(19) United States
(12) Patent Application Publication
(10) Pub. No.: US 2022/0186473 A1
(43) Pub. Date: Jun. 16, 2022

(54) FLUID DISTRIBUTION UNIT FOR SANITARY CHANGEOVER FITTINGS

(71) Applicant: Fluehs Drehtechnik GmbH, Luedenscheid (DE)

(72) Inventors: Friedrich THURAU, Herscheid (DE); Joerg WENDT, Luedenscheid (DE)

(73) Assignee: Fluehs Drehtechnik GmbH, Luedenscheid (DE)

(21) Appl. No.: 17/436,749

(22) PCT Filed: Jul. 27, 2020
(86) PCT No.: PCT/EP2020/071114

§ 371 Date: Sep. 7, 2021

(30) Foreign Application Priority Data
Jan. 8, 2020 (EP) 20150755.5

(51) Int. Cl. E03C 1/02; F16L 41/03

(52) U.S. Cl. CPC E03C 1/023; E03C 2201/30; F16L 41/03

(57) ABSTRACT

A distribution unit for sanitary changeover fittings for installation in a wall, includes a manifold with an inlet duct and at least two outlet ducts and a control block with an inlet duct and at least two valve seats for receiving a valve upper part each, which are connected to the inlet duct, wherein the inlet duct of the manifold is connected to the inlet duct of the control block and the outlet ducts of the manifold are connected to a valve seat each of the control block, in each case via a pipe section, and wherein, via the pipe sections, the control block is connected to the manifold in a manner such that these can move relative to one another.

The invention relates to a distributor unit for sanitary changeover fittings for installation in a wall, according to claim 1.

Sanitary flush-mounted batteries usually comprise a mixer, via which a desired water temperature can be adjusted mechanically or else thermostatically. Especially for shower or bathtub fittings, this mixer is connected downstream from a changeover fitting, via which it is possible to adjust an allocation of the water flow to different dispensing points, such as tub filler or shower faucet, for example. Modern wellness showers may even have three or more water dispensing points (such as, for example, overhead sprays, hand sprays, side sprays), which are controllable via such a changeover fitting. The control of the water supply flow then takes place via a corresponding number of shutoff valves, which are respectively disposed in a branch of the inlet line fed by the mixer and can be operated via the changeover fitting.

What has proved problematic for such changeover fittings in practice is the positionally correct laying of the line couplings by the line installer, since the individual valves are to be installed flush with the plane of the wall surface and positionally correctly in the shell wall. In DE 78 20 423 U1, a flush-mounted installation unit for sanitary mixing batteries with changeover is described. Therein it is proposed to use, in the wall, a mounting box having, mounted in the side walls, coupling means for the hot-water and cold-water delivery pipes and for the faucet pipes. The coupling means are screwed inside the mounting box into coupling nozzles of a battery housing, which is fixed therein and which contains the shutoff valves for cold and hot water as well as the coupling points for the mixing and changeover devices to be mounted. The installation unit formed in this way is to be installed on the construction site in a manner flush with the plane of the wall surface as well as positionally correctly in the upper wall and is intended to function as a template for the line installer when connecting the lines.

In practice, however, the problem of positionally correct installation exists even in this already known installation device. If it is found during final mounting of the fitting that the flush-mounted installation unit has not been positioned exactly correctly, corrections are usually possible only with great time and effort.

Here the invention seeks to create a remedy. The task underlying the invention is to provide a distributor unit for sanitary changeover fittings for installation in a wall, with which unit a readjustment for positioning of the disposed changeover valves flush with the wall is made easily possible. According to the invention, this task is accomplished by a distributor unit having the features of claim 1.

By virtue of the invention, a distributor unit for sanitary changeover fittings for installation in a wall is provided, with which unit a simple readjustment for positioning of the disposed shutoff valves flush with the wall is made possible. By the fact that the distributor unit is formed from a manifold having an inlet duct and at least two outlet ducts as well as a control block having an inlet duct and at least two valve seats for receiving respectively a valve upper part, which are connected to the inlet duct, wherein the inlet duct of the manifold is connected to the inlet duct of the control block the outlet ducts of the manifold are connected to respectively a valve seat of the control duct via respectively a line part, wherein the control block is connected to the valve block via the line parts in such a way that they are movable relative to one another, the position of the control block relative to the position of the manifold is adjustable. On the construction site, the manifold may now be installed in the shell wall, after which the line coupling to the manifold is made. The exact positioning of the control block may be achieved later in the course of mounting of the fitting. Positional deviations of the manifold installed permanently in the wall can be compensated for easily in this way.

In a further development of the invention, at least a line part is formed as a telescoping pipe, which comprises at least two pipe parts inserted sealingly one into the other. Hereby a stable connection of manifold and control block is made possible with simultaneous length adaptation of the line part. The line parts constructed as telescoping pipe and consisting of rigid pipe parts inserted one into the other permit an infinitely variable adaptation of the distance between manifold and control block. Manifold and control block are then connected preferably exclusively via the line parts.

Particularly preferably, all line parts are constructed as telescoping pipe, as described in the foregoing. It is indeed also possible to construct individual line parts by flexible tubes. Hereby, however, the stability of the connection of manifold and control block would be impaired, which in turn would necessitate an arrangement of additional connecting elements, which would be constructed in such a way that the adjustability of the position of the control block is not impaired.

In the configuration of the invention, the line parts are respectively constructed at their ends in the shape of spherical segments and are held in swiveling relationship with one end in a ball socket of the distributor pipe with the other end in a ball socket of the control block, wherein the ball socket of the control block opens respectively into an inlet duct or a valve seat and the ball socket of the manifold opens into an inlet duct or an outlet duct. Hereby an articulated connection of the line parts with the manifold as well as the control block is achieved, whereby a simple positional connection of the control block relative to the manifold is made possible. The line parts for this purpose are connected in the manner of a ball joint with the manifold and the control block, wherein the ends of the line parts respectively form a joint head that is mounted in a ball socket.

In a further configuration of the invention, at least one ball socket is formed in part by a ring nut, which is screwed into the manifold or the control block and via which a spherical-segment-shaped end of a line part is fastened in swiveling relationship. Hereby a simple mounting of the line part on the manifold as well as the control block is made possible. The ring nut screwed into the manifold or the control block forms, together therewith, the ball socket for a spherical-segment-shaped end of a line part functioning as a joint head.

In a further development of the invention, at least one ball socket has at least one sealing element for sealing relative to a spherical-segment-shaped end of a line part received by the ball socket. Hereby an escape of water at the line coupling points is opposed. Preferably the sealing element is formed by a sealing ring, especially by an O-ring. This sealing element may be disposed in the ring nut and/or in the manifold or the control block.

In one configuration of the invention, the valve seats have a female thread for screwing-in of a valve insert. Hereby a simple mounting of the valve inserts is made possible, even for repair purposes.

In a further configuration of the invention, the manifold has rectangular structure, wherein at least one outlet duct has angled structure and is guided by two adjacent sides of the manifold. This outlet duct is preferably formed at an angle of 90°. Hereby an orthogonal alignment of the coupling points of the line parts to the coupled lines is achieved. Obviously the manifold may also have a different, preferably elongated shape, wherein the contact surface provided for mounting in a wall opening should preferably have flat structure.

In a further development of the invention, the outlet ducts of the manifold respectively have a thread for coupling of an outlet line. Hereby the mounting of the coupling lines in the wall is simplified. Preferably the thread is formed as a female thread.

In a further development of the invention, the inlet duct of the manifold is connected via a main valve to at least one fluid source. This main valve is preferably a mixing valve, especially a thermostat valve, which is connected in known manner to a cold-water source and a hot-water source.

In a further configuration of the invention, the main valve is connected via a line part to the inlet duct, which has a spherical-segment-shaped end, which is received in swiveling relationship by a ball socket of the manifold opening into the inlet duct. Hereby a positional adjustment between manifold and main valve is made possible.

In a further development of the invention, a shutoff-valve insert, which has a lateral inlet in communication with the inlet duct, is respectively introduced into the valve seats of the manifold, wherein the outlet of the shutoff-valve insert is connected sealingly to the associated line part.

Other further developments and configurations of the invention are specified in the other dependent claims. An exemplary embodiment of the invention is illustrated in the drawings and will be described in detail in the following, wherein:

FIG. 1 shows the schematic diagram of a distributor unit in longitudinal section with indicated main valve;

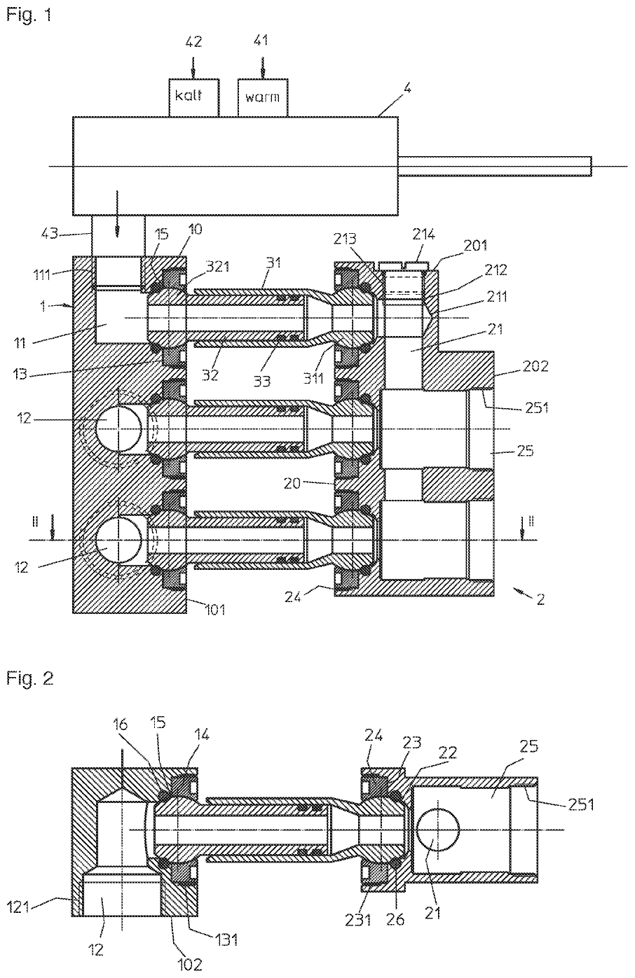

FIG. 2 shows the diagram of the distributor unit from FIG. 1 in section II-II;

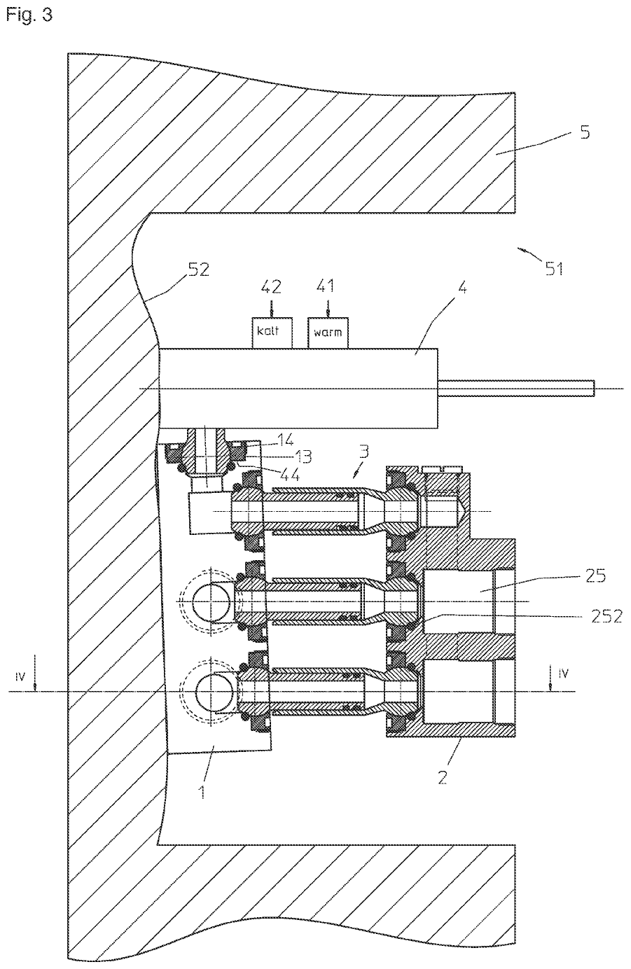

FIG. 3 shows the schematic diagram of the distributor unit from FIG. 1 in a wall opening and

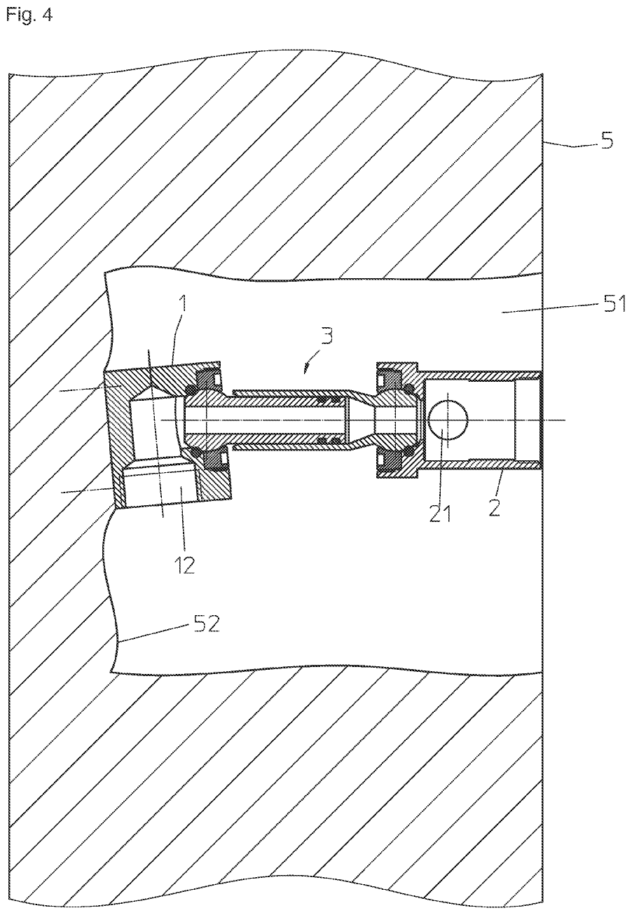

FIG. 4 shows the installation situation from FIG. 3 in section IV-IV.

The distributor unit chosen as the exemplary embodiment consists substantially of a manifold 1, which is connected via line parts 3 to a control block 2. The manifold 1 is formed as a rectangular brass block and is provided at a front side 10 with an inlet duct 11, which is angled by 90° and opens into the top surface 101 of the manifold 1 facing the control block 2. At the front side, the inlet duct 11 is provided with a female thread 111 for coupling of the outlet line 43 of a thermostat mixing valve 4. Spaced apart from the inlet duct 11, two outlet ducts 12, which are angled by 90° and open into the top surface 101 of the manifold 1, are disposed in a side surface 102 adjacent to the top surface 101. Framing the inlet duct 11 as well as the outlet ducts 12 in a manner concentrically therewith, a hollow-cylindrical recess 13, which is provided with a female thread 131, into which respectively a ring nut 14 is screwed, is made in the manifold 1. The inner wall of the ring nut 14 is spherical-segment-shaped with concave curvature. This curvature is continued in the transition from the hollow-cylindrical recess 13 to the outlet duct 12 and to the inlet duct 11, so that a ball socket 15 is formed in which respectively a joint head 321 of a line part 3 is mounted in swiveling relationship.

In the transition from the inlet duct 11 as well as the outlet ducts 12 to the respective hollow-cylindrical recess 13, respectively an annular groove is made, in which an O-ring 16 for sealing the line part 3 relative to the inlet duct 1 or the outlet ducts 12 is inserted. At their end facing the side surface 102, the outlet ducts 12 are respectively provided with a female thread 121 for coupling of installation lines.

The control block 2 is constructed in the exemplary embodiment as a rectangular brass block. In its underside 20 facing the manifold 1, a first blind hole 211 is made that opens into a second blind hole 212 made centrally in the front side 201 of the control block 2. The second blind hole 212 is provided at the front end with a female thread 213, into which a threaded plug 214 is screwed. An inlet duct 21 is formed by the first blind hole 211 and the second blind hole 212.

By analogy with the configuration of the top surface 101 of the manifold 1, three ball sockets 22 for receiving respectively a joint head 311 of a line part 3 are disposed spaced apart from one another in the underside 20 of the control block 2. One of these ball sockets 22 opens into the first blind hole 211 of the inlet duct 21. Respectively a further ball socket 22 opens into a hollow-cylindrical valve seat 25 made in the top surface 202 of the control block 2. Framing the ball sockets 22, respectively a hollow-cylindrical recess 23, which is provided with a female thread 231, into which a ring nut 24 is screwed, is in turn made in the control block 2. The inner contour of this ring nut 24 in turn forms, together with the transition of the first blind hole 211 or of a valve seat 25 to the hollow-cylindrical recess 23, the spherical-segment-shaped contour of the ball socket 22, wherein an annular groove, which an O-ring 26 for sealing the control block 2 relative to the joint head 311 respectively received by the ball socket 22 is respectively received, is again made in the transitions. The valve seats 25 are provided on their end at the top side with a female thread 251 for screwing-in of a shut-off valve insert (not illustrated).

The line parts 3 are formed in the exemplary embodiment by a first pipe part 31 and a second pipe part 32 inserted into this, wherein a joint head 311 is formed on the first pipe part 31 at its end opposite the second pipe part 32. At its end facing away from the first pipe part 31, a joint head 321 is formed correspondingly on the second pipe part 32. At its end facing the first pipe part 31, two external annular grooves disposed parallel to one another, in which an O-ring 33 for sealing relative to the first pipe part 31 is respectively positioned, are made circumferentially in the second pipe part 32.

An installation situation of a distributor unit according to the invention is illustrated in FIG. 3. In this case the manifold 1 is fastened on the base 52 of a wall opening 51 made in a wall 5. As indicated in FIGS. 3 and 4, a the base of the wall opening does not have flat structure. The outlet line 43 of a thermostat valve 4, which is also fastened on the base 52 of the wall opening 51, is coupled to the inlet duct 11 of the manifold 1. The thermostat valve 4 is connected with its hot-water inlet coupling 41 to a hot-water source (not illustrated) and with its cold-water inlet coupling 42 to a cold-water source (not illustrated). In the exemplary embodiment according to FIG. 3, the outlet line 43 of the thermostat mixing valve 4 is provided at the end side with a joint head 44 of spherical-segment-shaped structure, wherein the inlet duct 11 of the manifold 1 opens by analogy with the foregoing embodiments into a ball socket 15, which receives the joint head 44 of the outlet line 43 of the thermostat mixing valve 4. This ball socket 15 is in turn framed by a hollow-cylindrical recess 13, in which a ring nut 14 is screwed, the inner contour of which is part of the ball socket 15 and via which the joint head 44 is held in swiveling relationship on the manifold 1.

The control block 2 is connected via the line part 3 to the manifold 1, which is fastened on the base 52 of the wall opening 51. Due to the telescoping configuration of the line parts 3 as well as to their ball-joint-shaped connection with the manifold 1 on the one hand and with the control block 2 on the other hand, a simple alignment of the control block 2 is made possible without the need for a positional correction of the manifold 1 fastened in the wall opening 51.

A shutoff-valve insert, which has a lateral inlet as well as bottom-side outlet, which can be closed via a control disk and is in contact with a sealing ring, is now inserted respectively into each valve seat 25 of the control block 2. The shutoff valve insert—generally also called valve cartridge or valve upper part—is fixed in known manner via a union-type sleeve, which is provided with a male thread and is screwed into the female thread 251 of the valve seat 25, and is pretightened with the sealing ring of the outlet against the sealing seat 252 of the valve seat 25. Shutoff valve inserts of the foregoing type are generally known and are described, for example, in EP 1462692 A1.

Depending on valve position of a valve upper part mounted in a valve seat 25, the inlet to the line part 3, which is received by the ball socket 22 opening into the valve seat 25, is enabled or blocked. Regardless of the valve position, an unhindered flow through the inlet duct 21 of the control block 2 is assured.

1: A distributor unit for sanitary changeover fittings for installation in a wall (5), comprising a manifold (1) with an inlet duct (11) and at least two outlet ducts (12) as well as a control block (2) with an inlet duct (21) and at least two valve seats (25) for receiving respectively a valve upper part, which are connected to the inlet duct (21), wherein the inlet duct (11) of the manifold (1) is connected to the inlet duct (21) of the control block (2) and the outlet ducts (12) of the manifold (1) are connected respectively to a valve seat (25) of the control block (2) via respectively a line part (3), and wherein the control block (2) is connected to the manifold (1) via the line parts in such a way that they are movable relative to one another.

2: The distributor unit according to claim 1, wherein the control block (2) is connected to the manifold exclusively via the line parts (3).

3: The distributor unit according to claim 1, wherein at least one line part (3) is formed as a telescoping pipe, which comprises at least two pipe parts (31, 32) inserted sealingly one into the other.

4: The distributor unit according to claim 1, wherein the line parts (3) are respectively constructed in the manner of spherical segments at their ends and are held in swiveling relationship with one end in a ball socket (15) of the manifold (1) with the other end in a ball socket (22) of the control block (2), wherein the ball sockets (22) of the control block (2) open respectively into an inlet duct (21) or a valve seat (25) and the ball sockets (15) of the manifold (1) open into an inlet duct (11) or an outlet duct (12).

5: The distributor unit according to claim 4, wherein at least one ball socket (15, 22) is formed in part by a ring nut (14, 24), which is screwed into the manifold (1) or the control block (2) and via which a spherical-segment-shaped end of a line part (3) is fastened in swiveling relationship.

6: The distributor unit according to claim 4, wherein at least one ball socket (15, 22) has at least one sealing element, especially a sealing ring for sealing relative to a spherical-segment-shaped end of a line part (3) received by the ball socket (15, 22).

7: The distributor unit according to claim 1, wherein at least one valve seat (25) has a female thread for screwing-in of a valve insert.

8: The distributor unit according to claim 1, wherein the manifold (1) has a rectangular structure, wherein at least one outlet duct (12) has angled structure and is guided by two adjacent sides of the manifold (1).

9: The distributor unit according to claim 1, wherein the outlet ducts (12) of the manifold respectively have a thread for coupling of an outlet line.

10: The distributor unit according to claim 1, wherein the inlet duct (11) of the manifold (1) is connected via a main valve to at least one fluid source.

11: The distributor unit according to claim 10, wherein the main valve is a mixing valve, preferably a thermostat mixing valve (4), which is connected to a cold-water source and a hot-water source.

12: The distributor unit according to claim 10, wherein the main valve is connected via a line part (3) to the inlet duct (11), which has a spherical-segment-shaped end, which is received in swiveling relationship by a ball socket (15) of the manifold (1) opening into the inlet duct (11).

13: The distributor unit according to claim 1, wherein a shutoff-valve insert, which has a lateral inlet in communication with the inlet duct, is respectively introduced into the valve seats (25) of the manifold (2), wherein the outlet of the shutoff-valve insert is connected sealingly to the associated line part (3).
